(19) United States
(12) Patent Application Publication
(10) Pub. No.: US 2024/0221357 A1
(43) Pub. Date: Jul. 4, 2024

(54) THREE-STAGE MODULARIZED CONVOLUTIONAL NEURAL NETWORK FOR RAPIDLY CLASSIFYING CONCRETE CRACKS

(71) Applicants: Hohai University, Nanjing City (CN); Jiangxi University of Science and Technology, Ganzhou City (CN)

(72) Inventors: Maosen CAO, Nanjing City (CN); Ronghua FU, Nanjing City (CN); Yufeng ZHANG, Nanjing City (CN); Tongfa Deng, Ganzhou City (CN); Shuai LI, Nanjing City (CN); Dragoslav Sumarac, Nanjing City (CN)

(73) Assignees: Hohai University, Nanjing City (CN); Jiangxi University of Science and Technology, Ganzhou City (CN)

(21) Appl. No.: 18/398,205

(22) Filed: Dec. 28, 2023

(30) Foreign Application Priority Data
Dec. 29, 2022 (CN) 2022117054944

(51) Int. Cl. G06V 10/764; G06T 7/00; G06V 10/77; G06V 10/774; G06V 10/82

(52) U.S. Cl. CPC G06V 10/764; G06T 7/0002; G06V 10/7715; G06V 10/774; G06V 10/82; G06T 2207/20081; G06T 2207/20084

(57) ABSTRACT

A three-stage modularized convolutional neural network (CNN) called Stairnet is disclosed for efficient classification of concrete cracks in images. Unlike traditional CNNs which exhibit similar structural characteristics in each layer, Stairnet is composed of three distinct parts: stair1, stair2, and stair3, each possessing its own unique structural characteristics. Stair1 exclusively consists of convolution layers, while stair2 incorporates a greater number of layers. Stair3, on the other hand, utilizes larger expansion factors and kernel size. Stair1 and stair2 exhibit various variations that result in their modification alongside certain parameters of Stairnet. In contrast to traditional CNNs utilized for the classification of thousands of classes, Stairnet stands out with its smaller model size, faster training speed, and high accuracy in classifying concrete cracks.

### TECHNICAL FIELD

The present disclosure relates to the technical field of concrete crack pattern classification, and in particular to a three-stage modularized convolutional neural network (CNN) for rapidly classifying concrete cracks in images. The proposed network could also be used as backbones for efficient feature extraction in the object detection algorithms.

### BACKGROUND ART

Concrete buildings are inevitably subject to damage from both man-made and environmental factors. One of the most common types of damage is the occurrence of cracks. Therefore, there is a need for efficient and accurate classification of these cracks. The advancement of unmanned aerial vehicles (UAVs), crawling robots, and wireless transmission technology has paved the way for the collection of large-scale data on concrete buildings. This, in turn, opens up possibilities for the development of intelligent classification systems for apparent cracks in concrete structures.

Compared to the traditional manual classification, crack classification using deep learning offers several advantages, including high accuracy and fast detection speed. However, deep learning neural networks, originating from the computer field, are characterized by their large size for classifying thousands of classes. They have a substantial number of convolutional layers that possess similar structural characteristics.

They are unsuitable for rapidly classifying concrete cracks.

### SUMMARY OF THE INVENTION

The present disclosure proposes a three-stage modularized CNN for rapidly classifying concrete cracks in images, comprising the following steps.

A concrete crack dataset is built for training the CNN.

The structure of the three-stage modularized CNN, which could be called Stairnet, consists of an input layer, blocks of stair1 in shallow layers, a convolutional block attention module (CBAM), blocks of stair2 in mid-layers, another CBAM, blocks of stair3 in deep layers, and a fully connected layer.

Once the Stairnet model has been successfully trained, it can be employed to classify the class of concrete cracks in images by inputting the concrete crack images into the model.

The shallow layers of the model can be referred to as stair1 and are constructed using inverted residual blocks that exclusively consist of convolutions (Convs).

The mid-layer of the model can be referred to as stair2. When the stride is set to 1, the stair2 structure involves performing a split operation on the input channel. One part of the channel passes through an inverted residual structure that includes a depthwise separable convolution (DConvs), while the other part does not undergo any operation. Afterward, a shuffle operation is performed on the two channels that are concatenated. On the other hand, when the stride is set to 2, the stair2 structure involves copying the input channel. One part of the channel is reduced in dimension through an inverted residual structure with a depthwise separable convolution, another part is reduced in dimension through the depthwise separable convolution, and the third part is reduced in dimension through maximum pooling. Finally, a shuffle operation is performed on the three channels that are reduced in dimension after performing a concatenate operation.

The deep layer of the model can be referred to as stair3, including inverted residual structures containing depthwise separable convolutions and efficient channel attention (ECA) modules.

Preferably, the expansion factor of the stair1 structure is 1 or not.

Preferably, the input layer includes a convolution layer, a batch normalization (BN) layer, and an activation function (AF) layer.

Preferably, the normalization processing of the BN layer is shown in the following formulas:

$${μ}_{ℬ} = \frac{1}{m} {\sum }_{i = 1}^{m} {x}_{i} \\ {σ}_{ℬ}^{2} = \frac{1}{m} {\sum }_{i = 1}^{m} {( {x}_{i} - {μ}_{ℬ} )}^{2} \\ {\hat{x}}_{i} = \frac{{x}_{i} - {μ}_{ℬ}}{\sqrt{{σ}_{ℬ}^{2} + ϵ}} \\ {y}_{i} ← γ {\hat{x}}_{i} + β ,$$

where xᵢ is a feature map before inputting to the BN layer; yᵢ is a feature map after outputting from the BN layer; m is the number of feature maps input to the layer in the current training batch; and γ and β are variables that vary with network gradient renewal.

Preferably, the AF layer performs non-linear processing via ReLU6:

$$f ( {x}_{i} ) = min ( max ( {x}_{i} , 0 ) , 6 ) ,$$

where xᵢ is a feature map before inputting the ReLU6, and f(xᵢ) is a feature map after outputting the ReLU6.

Preferably, another AF layer performs non-linear processing via data of a Hardswish:

$$Hardswish ( x ) = \{ \begin{matrix}0 & if x \leq - 3 \\ x & if x \geq + 3 \\ x \cdot ( x + 3 ) / 6 & otherwise\end{matrix} ,$$

where x is a feature map before inputting the Hardswish, and f(x) is a feature map after outputting the Hardswish.

Preferably, the ECA attention mechanism performs cross-channel interaction on data to obtain an enhanced concrete crack feature extraction map;

$$k = ψ ( C ) = {\vert \frac{{log}_{2} ( C )}{γ} + \frac{b}{γ} \vert}_{odd} \\ {E}_{s} ( F ) = σ ( {f}^{k * k} [ AvgPool ( F ) ] ) ,$$

where |t|_{odd} represents the nearest odd t; C represents the number of channels inputting data into the ECA attention mechanism, and γ and b are two hyper-parameters; γ is set to 2 and b is set to 1; Eₛ(F) is the ECA attention mechanism, σ is a sigmoid operation, f*^{*k} [·] represents performing a k*k convolution operation, F is the input feature map, and AvgPool( ) is the average pooling operation.

Preferably, in the CBAM attention mechanism, the average pooling and maximum pooling are used to aggregate spatial information of the feature map, compress spatial dimensions of the input feature map, and sum and merge element by element to generate a channel attention map:

$${M}_{c} ( F ) = σ ( MLP ( AvgPool ( F ) ) + MLP ( Max Pool ( F ) ) ) ,$$

where Mc represents the channel attention, and MLP( ) is composed of fully connected layer 1+ReLU6+fully connected layer 2; σ is the sigmoid operation, F is the input feature map, AvgPool( ) is the average pooling, MaxPool( ) is the maximum pooling, Mₛ represents the spatial attention mechanism, σ is the sigmoid operation; and

the average pooling and the maximum pooling methods are used to compress the input feature map in a spatial attention module, to obtain a feature extraction map containing more crack information:

$${M}_{s} ( F ) = σ ( {f}^{7 * 7} [ AvgPool ( F ) , Max Pool ( F ) ] ) ,$$

where Mₛ represents the spatial attention mechanism, σ is the sigmoid operation, f^{7*7} [·] represents performing a 7*7 convolution operation, F is the input feature map, AvgPool( ) is the average pooling, and MaxPool( ) is the maximum pooling.

Preferably, there further includes:

sparsifying data passing through a dropout layer in each layer to avoid network over-fitting:

$${r}_{j}^{( l )} \sim Bernoulli ( p ) \\ {\tilde{y}}^{( l )} = {r}^{( l )} * {y}^{( l )} ,$$

where the Bernoulli(p) function is used to generate a probability rⱼ⁽ⁱ⁾ vector, to enable a neuron to stop working with the probability p; y⁽¹⁾ is an output feature map of the previous layer; \tilde{y}^{(l)} is a feature map output after passing through the dropout layer.

Preferably, there further includes:

optimizing network internal parameters using the following Adam algorithm:

$$f ( θ ) = Loss ( {y}_{o , c} , {p}_{o , c} ) \\ {g}_{t} = {∇}_{θ} {f}_{t} ( {θ}_{t - 1} ) \\ {m}_{1} = {β}_{1} \cdot {m}_{t - 1} + ( 1 - {β}_{1} ) \cdot {g}_{t} \\ {v}_{t} = {β}_{2} \cdot {v}_{t - 1} + ( 1 - {β}_{2} ) \cdot {g}_{t}^{2} \\ {\hat{m}}_{t} = {m}_{t} / ( 1 - {β}_{1}^{t} ) \\ {\hat{v}}_{t} = {v}_{t} / ( 1 - {β}_{2}^{t} ) \\ {θ}_{t} = {θ}_{t - 1} - α \cdot {\hat{m}}_{t} / ( \sqrt{{\hat{v}}_{t}} + ϵ ) ,$$

where Loss(y_{o. c}, p_{o. c}) is a loss function between a predicted value and a true value of the network; θ is a parameter to be updated in the model; gₜ is a gradient obtained by deriving θ from the loss function f(θ); β₁ is a first-moment attenuation coefficient; β₂ is a second-moment attenuation coefficient; mₜ is an expectation of the gradient gₜ; vₜ is an expectation of gₗ², \hat{m}ₜ is an offset correction of mₜ; \hat{v}ₜ is an offset correction of vₜ; θₜ₋₁ is a parameter before the network update; θₜ is a parameter after the network update; and a is a learning rate.

The advantageous effects of the present disclosure are as follows:

The present disclosure proposes a three-stage modularized CNN aimed at rapidly classifying concrete cracks in images. CNN model like AlexNet, vgg16, resnet50, GoogLeNet, or mobilenet_v3_large has similar structures across its layers. However, these models tend to be large and relatively slow in classifying concrete cracks. In contrast, the proposed model, named Stairnet, exhibits distinct feature characteristics in its early, middle, and deep layers. The three-stage modularized structure of Stairnet is specifically designed to be smaller in size, have shorter training time, and achieve the highest accuracy in concrete crack classification. Furthermore, Stairnet can serve as a backbone for efficient feature extraction in object detection algorithms.

### BRIEF DESCRIPTION OF DRAWINGS

FIG. 1 is a flowchart for concrete cracks classification using Stairnet according to an embodiment of the present disclosure;

FIG. 2 is an illustration of the concrete crack images in the dataset according to an embodiment of the present disclosure;

FIG. 3 (a) is an operation diagram of blocks in stair1 according to an embodiment of the present disclosure;

FIG. 3 (b) is an operation diagram of blocks in stair2 according to an embodiment of the present disclosure;

FIG. 3 (c) is an operation diagram of blocks in stair3 according to an embodiment of the present disclosure;

FIG. 4 is an illustration of Stairnet according to an embodiment of the present disclosure;

FIG. 5 (a) is an illustration of convs according to an embodiment of the present disclosure;

FIG. 5 (b) is an illustration of DConvs according to an embodiment of the present disclosure;

FIG. 6 (a) is the training accuracy of Stairnet and the other compared models during training according to an embodiment of the present disclosure;

FIG. 6 (b) is the training loss of Stairnet and the other compared models during training according to an embodiment of the present disclosure;

FIG. 6 (c) is the validation accuracy of Stairnet and the other compared models during training according to an embodiment of the present disclosure;

FIG. 6 (d) is the validation loss of Stairnet and the other compared models during training according to an embodiment of the present disclosure.

### DETAILED DESCRIPTION OF THE EMBODIMENTS

The present disclosure is described in detail in combination with the drawings and embodiments. The specific embodiments described herein are intended only to explain the present disclosure and are not intended to limit it.

### Embodiment 1

The three-stage modularized CNN in the present disclosure is implemented using PyTorch and further details can be found in Table 1:

TABLE 1
Computer platform and environment configuration
used in the embodiment

| Hardware and software platform | Model parameter |
|---|---|
| Operating system | Windows 10 |
| CPU | Intel(R) Xeon(R) Gold 5222 CPU |
| | @ 3.80 GHz 3.79 GHz |
| GPU | NVIDIA Quadro P2200 |
| Memory | 64.0 GB |
| | Anaconda3 |
| Programming | CUDA10.2 |
| environment | Python3.6 |
| | pytorch |

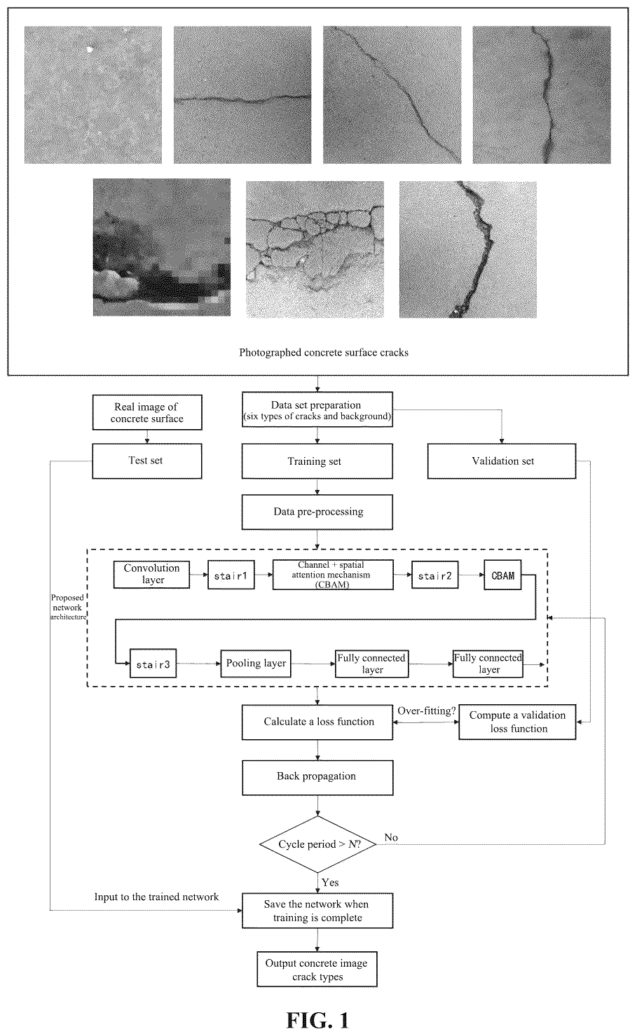

FIG. 1 depicts the concrete cracks classification using the three-stage modularized CNN in the present disclosure, including the following steps:

Step 1, a concrete crack dataset is built for training the CNN;

Step 2, stair1 is utilized as the shallow layers of the network;

Step 3, stair2 is utilized as the mid-layers of the network;

Step 4, stair3 is utilized as the deep layer of the network;

Step 5, based on the three stairs1-3, combining deep learning algorithms for example attention mechanisms, forming the Stairnet, and the dataset is used for training the Stairnet until the model converges

Step 6, multiple concrete crack images can be fed into the well-trained stairNet to obtain the crack classes in the images.

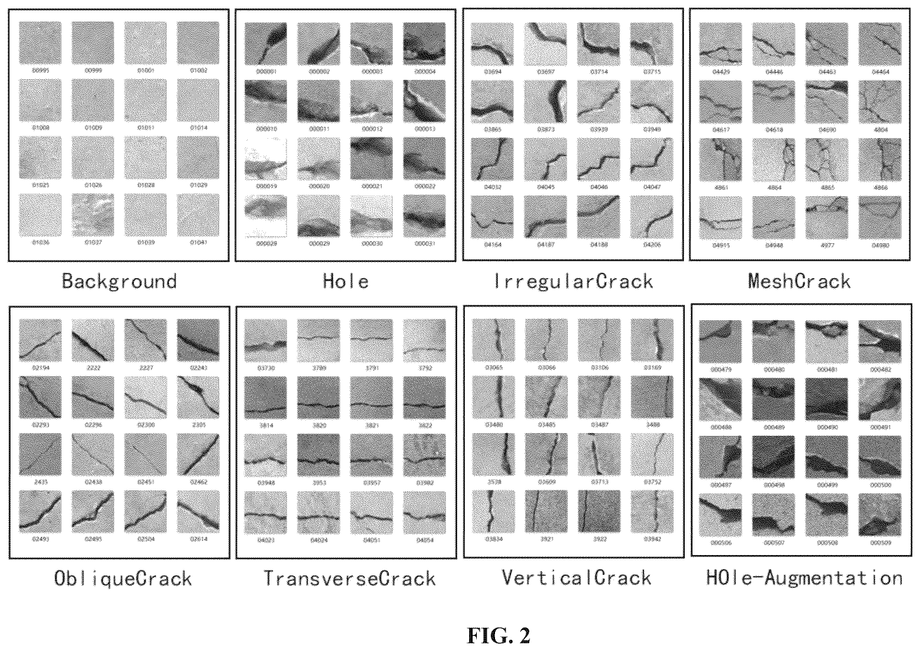

Aiming to build the dataset in step 1, the concrete crack images are manually classified. The crack classes include transverse crack, vertical crack, oblique crack, mesh crack, irregular crack, hole, and no crack (background), as shown in FIG. 2; hole-data augmentation is based on digital image processing techniques, for example, adding random pixels, changing color temperature, perspective transformation, horizontal inversion, random pixel zeroing, motion blur, gaussian noise and unequal scaling, are used for data augmentation. They are randomly mixed to address the data-imbalanced problem. The dataset, consisting of ten thousand images, comprises a training set and a validation set. Images are classified into seven classes. The training set contains 7 parts out of 10, while the remaining 3 parts form the validation set.

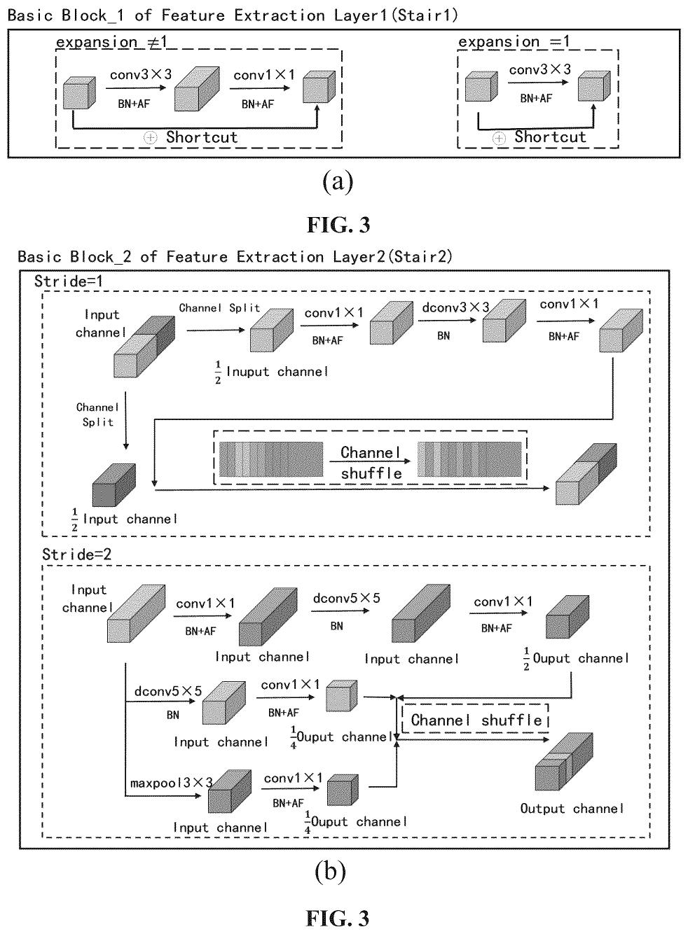

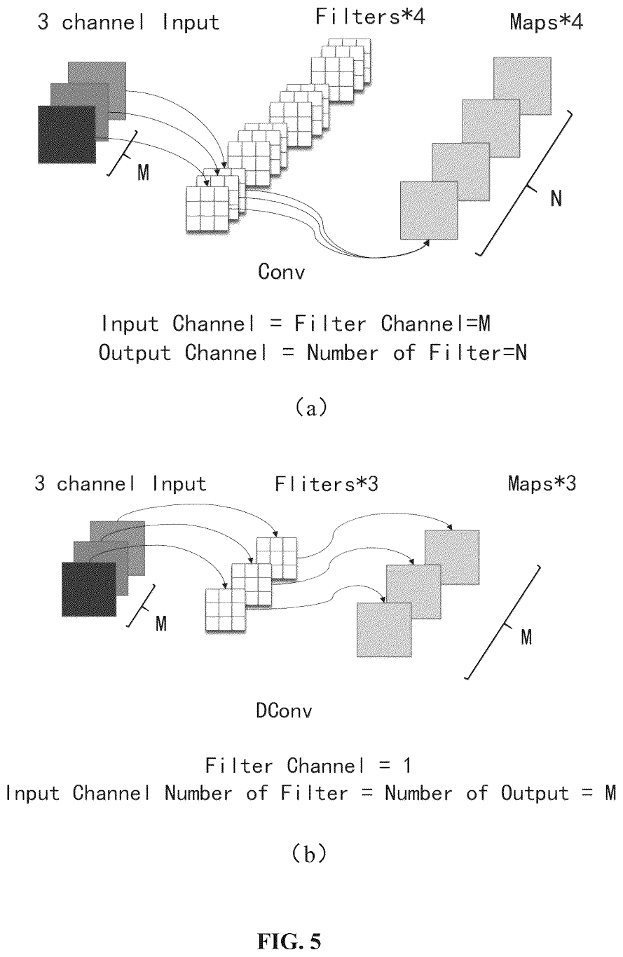

In Step 2, stair1 is composed of inverted residual structures that exclusively utilize convolutions. There are two variations in stair1, depending on whether the expansion factor is 1 or not. The structure of stair1 is depicted in FIG. 3 (a), and the convolution operation (Conv) is illustrated in FIG. 5 (a). The structural characteristic in stair1 is that stair1 exclusively consists of Convs.

In Step 3, the structure of stair2 in step 3 is shown in FIG. 3 (b). The structural characteristic in stair2 is that stair2 has more layers, compared with stair1 and stair3. The structural blocks in stair2 consist of two variations.

When the stride is set to 1, the stair2 structure involves performing a split operation on the input channel. One part of the channel passes through an inverted residual structure that includes a depthwise separable convolution (DConvs), while the other part does not undergo any operation. Afterward, a shuffle operation is performed on the two channels that are concatenated. The structure of the depthwise separable convolution is shown in FIG. 5 (b).

When the stride is set to 2, the stair2 involves copying the input channel. One part of the channel is reduced in dimension through an inverted residual structure with a depthwise separable convolution, another part is reduced in dimension through the depthwise separable convolution, and the third part is reduced in dimension through maximum pooling. Finally, a shuffle operation is performed on the three channels that are reduced in dimension after performing a concatenate operation.

In step 4, the structure of stair3 is as shown in FIG. 3 (c), including inverted residual structures containing depthwise separable convolutions and efficient channel attention (ECA) modules. As shown in table 2, the expansion factors in stair3 are bigger than those in stair1 and stair2. As shown in FIG. 3 (c), the kernel size for feature extraction in stair3 is bigger than that in stair1 and stair2. Therefore, the structural characteristic in stair3 is that stair3 has bigger expansion factors and kernel size, compared with stair1 and stair2

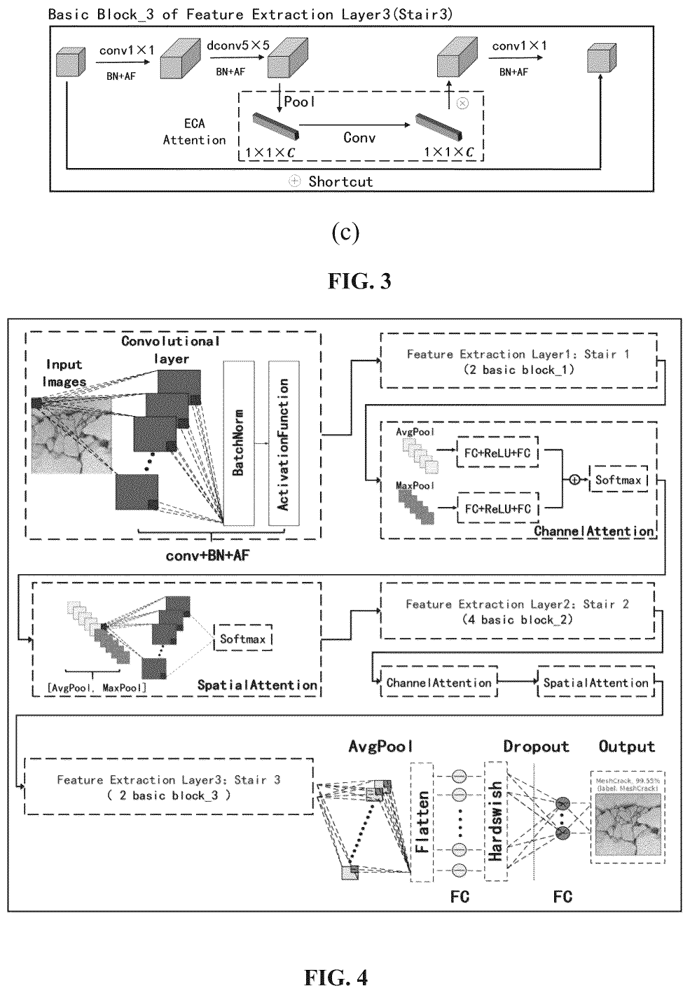

In step 5, the structure of the Stairnet is shown in FIG. 4. The parameters in each layer of Stairnet are shown in FIG. 2. Stairnet consists of an input layer, blocks of stair1 in shallow layers, a convolutional block attention module (CBAM), blocks of stair2 in mid-layers, another CBAM, blocks of stair3 in deep layers, and a fully connected layer. The activation functions (Afs) in Table 2 include HS (Hardswish) and RE (ReLU6).

TABLE 2
Parameters in Stairnet

| | Feature | Input(Height, | | | | | |
|---|---|---|---|---|---|---|---|
| | extraction | Width, | | Expansion | Output | | |
| | layer | channel) | Operator | factor | channel | AF | Stride |
| Shallow | Stair1 | 224 × 224 × 3 | conv2d | \ | 16 | HS | 2 |
| layer | | 112 × 112 × 16 | Basic block_1 | 2 | 24 | RE | 2 |
| | | 56 × 56 × 24 | Basic block_1 | 1 | 24 | RE | 1 |

Channel Attention
Spatial Attention

| | | | | | | | |
|---|---|---|---|---|---|---|---|
| Mid- | Stair2 | 56 × 56 × 24 | Basic block_2 | \ | 48 | RE | 2 |
| layer | | 28 × 28 × 48 | Basic block_2 | 1 | 48 | HS | 1 |
| | | 28 × 28 × 48 | Basic block_2 | \ | 96 | HS | 2 |
| | | 14 × 14 × 96 | Basic block_2 | 1 | 96 | HS | 1 |

Channel Attention
Spatial Attention

| | | | | | | | |
|---|---|---|---|---|---|---|---|
| Deep | Stair3 | 14 × 14 × 96 | Basic block_3 | 6 | 96 | HS | 2 |
| layer | | 7 × 7 × 96 | Basic block_3 | 6 | 96 | HS | 1 |
| | | 7 × 7 × 96 | pool, 7 × 7 | \ | \ | \ | 1 |
| | Classifier | 1 × 1 × 512 | conv2d, 1 × 1, | \ | 512 | HS | 1 |
| | | | NBN, dropout | | | | |
| | | 1 × 1 × 512 | conv2d, 1 × 1, | \ | k | \ | 1 |
| | | | NBN | | | | |

The normalization processing of the BN layer is shown in the following formulas:

$${μ}_{ℬ} = \frac{1}{m} {\sum }_{i = 1}^{m} {x}_{i} \\ {σ}_{ℬ}^{2} = \frac{1}{m} {\sum }_{i = 1}^{m} {( {x}_{i} - {μ}_{ℬ} )}^{2} \\ {\hat{x}}_{i} = \frac{{x}_{i} - {μ}_{ℬ}}{\sqrt{{σ}_{ℬ}^{2} + ϵ}} \\ {y}_{i} ← γ {\hat{x}}_{i} + β ,$$

where xᵢ is a feature map before inputting to the BN layer; yᵢ is a feature map after outputting from the BN layer; m is the number of feature maps input to the layer in the current training batch; and γ and β are variables that vary with network gradient renewal.

The AF layer performs non-linear processing via data of a ReLU6:

$$f ( {x}_{i} ) = min ( max ( {x}_{i} , 0 ) , 6 ) ,$$

where x; is a feature map before inputting the ReLU6, and f(xᵢ) is a feature map after outputting the ReLU6.

The AF layer performs non-linear processing via data of a Hardswish:

$$Hardswish ( x ) = \{ \begin{matrix}0 & if x \leq - 3 \\ x & if x \geq + 3 \\ x \cdot ( x + 3 ) / 6 & otherwise\end{matrix} ,$$

where x is a feature map before inputting the Hardswish, and f(x) is a feature map after outputting the Hardswish.

Specifically, the ECA attention mechanism performs cross-channel interaction on data to obtain an enhanced concrete crack feature extraction map;

$$k = ψ ( C ) = {\vert \frac{{log}_{2} ( C )}{γ} + \frac{b}{γ} \vert}_{odd} \\ {E}_{s} ( F ) = σ ( {f}^{k * k} [ AvgPool ( F ) ] ) ,$$

where |t|_{odd} represents the nearest odd t; C represents the number of channels inputting data into the ECA attention mechanism, and γ and b are two hyper-parameters; γ is set to 2 and b is set to 1; Eₛ(F) is the ECA attention mechanism, σ is a sigmoid operation, f*^{*k} [· ] represents performing a k*k convolution operation, F is the input feature map, and AvgPool( ) is the average pooling operation.

In the CBAM attention mechanism, the average pooling and maximum pooling are used to aggregate spatial information of the feature map, compress spatial dimensions of the input feature map, and sum and merge element by element to generate a channel attention map:

$${M}_{c} ( F ) = σ ( MLP ( AvgPool ( F ) ) + MLP ( Max Pool ( F ) ) ) ) ,$$

where Me represents the channel attention, and MLP( ) is composed of fully connected layer 1+ReLU6+fully connected layer 2; σ is the sigmoid operation, F is the input feature map, AvgPool( ) is the average pooling, MaxPool( ) is the maximum pooling, Mₛ represents the spatial attention mechanism, σ is the sigmoid operation; and

The average pooling and the maximum pooling methods are used to compress the input feature map in a spatial attention module, to obtain a feature extraction map containing more crack information:

$${M}_{s} ( F ) = σ ( {f}^{7 * 7} [ AvgPool ( F ) , Max Pool ( F ) ] ) ,$$

where Mₛ represents the spatial attention mechanism, σ is the sigmoid operation, f^{7*7} [·] represents performing a 7*7 convolution operation, F is the input feature map, AvgPool( ) is the average pooling, and MaxPool( ) is the maximum pooling.

The data passing through the dropout layer in each layer is sparsely processed to avoid network over-fitting:

$${f}_{j}^{( l )} \sim Bernoulli ( p ) \\ {\tilde{y}}^{( l )} = {r}^{( l )} * {y}^{( l )} ,$$

where the Bernoulli(p) function is used to generate a probability rⱼ⁽ⁱ⁾ vector, to enable a neuron to stop working with the probability p, and y⁽¹⁾ is an output feature map of the previous layer, and \tilde{y}⁽¹⁾ is a feature map output after passing through the dropout layer.

The following Adam algorithm is used to optimize the network internal parameters:

$$f ( θ ) = Loss ( {y}_{o , c} , {p}_{o , c} ) \\ {g}_{t} = {∇}_{θ} {f}_{t} ( {θ}_{t - 1} ) \\ {m}_{t} = {β}_{1} \cdot {m}_{t - 1} + ( 1 - {β}_{1} ) \cdot {g}_{t} \\ {v}_{t} = {β}_{2} \cdot {v}_{t - 1} + ( 1 - {β}_{2} ) \cdot {g}_{t}^{2} \\ {\hat{m}}_{t} = {m}_{t} / ( 1 - {β}_{1}^{t} ) \\ {\hat{v}}_{t} = {v}_{t} / ( 1 - {β}_{2}^{t} ) \\ {θ}_{t} = {θ}_{t - 1} - α \cdot {\hat{m}}_{t} / ( \sqrt{{\hat{v}}_{t}} + ϵ ) ,$$

where Loss(y_{o. c}, p_{o. c}) is a loss function between a predicted value and a true value of the network; θ is a parameter to be updated in the model; gₜ is a gradient obtained by deriving θ from the loss function f(θ); β₁ is a first-moment attenuation coefficient; β₂ is a second-moment attenuation coefficient; mₜ is an expectation of the gradient gₜ; vₜ is an expectation of gₜ², \hat{m}ₜ is an offset correction of mₜ; \hat{v}ₜ is an offset correction of vₜ; θₜ₋₁ is a parameter before the network update; θₜ is a parameter after the network update; and a is a learning rate.

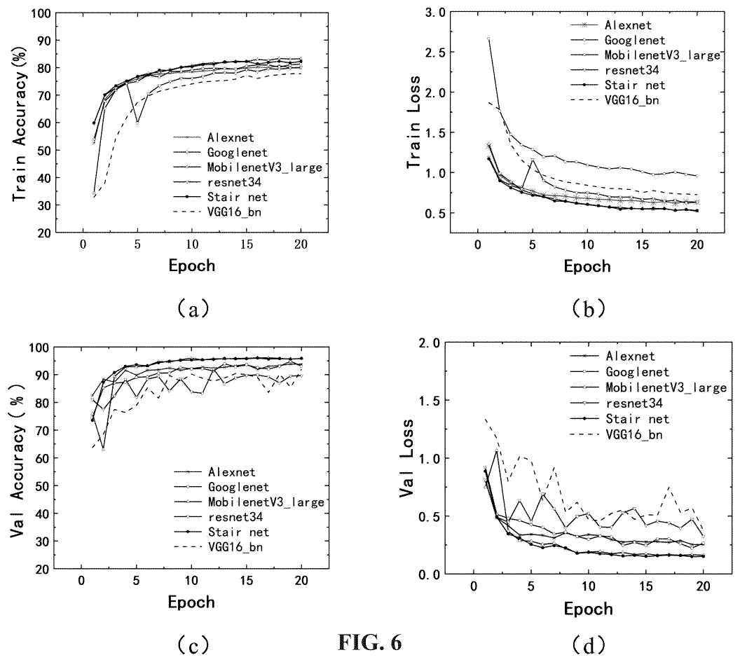

Stairnet, along with commonly used neural network models, namely AlexNet, GoogLeNet, vgg16_bn, resnet34, and Mobilenet_v3_large area trained and validated in this embodiment. The training process is illustrated in FIG. 1. FIG. 6 presents the training accuracy, training loss, validation (val) accuracy, and val loss during the training process. A higher accuracy with lower loss on the validation set indicates stronger classification capability of the network. The calculation formula for accuracy is as follows:

$$accuracy = \frac{{\sum }_{N} eq ( {y}_{o , c} , max ( {p}_{o , c} ) )}{N} ,$$

where y_{o. c} is the true value of a single image in a data set (training set/validation set); p_{o. c} is a predicted value of the network, including 7 probabilities, corresponding to 7 crack categories; max ( ) is the category corresponding to the value with the highest probability extracted in p_{o. c}; eq is used to verify whether the true value (label) y_{o. c} is equal to max (p_{o. c}); ΣN( ) is used to calculate the number of the true value (label) y_{o. c} of all the images in the data set is equal to max (p_{o. c}); and N is the number of all the crack images in the data set.

The loss is calculated as follows:

$$Loss ( {y}_{o , c} , {p}_{o , c} ) = - {\sum }_{c = 1}^{M} {y}_{o , c} log ( {p}_{o , c} ) \\ loss = \frac{{\sum }_{steps} Loss ( {y}_{o , c} , {p}_{o , c} )}{{N}_{steps}} \\ {N}_{steps} = \frac{N}{{N}_{batch}} ,$$

where Loss (y_{o. c}, p_{o. c}) is the error between the predicted value and the true value of the network calculated using cross entropy for a single image; M is the number of classes, taking 7 in this embodiment; Nₛₜₑₚₛ is the number the strides of network training; N is the number of all crack images in the data set; N_{batch} is the number of images included in a batch size, taking 16 in this embodiment.

FIG. 6 demonstrates that Stairnet achieves the fastest convergence speed, and exhibits slightly stronger performance in terms of accuracy and loss compared to MobilenetV3_large, outperforming other CNN models. Table 3 presents the evaluation metrics for all the networks in this embodiment. As shown in Table 3, Stairnet significantly outperforms other comparative CNNs in terms of model size and training time. Stairnet's model size is 1.48 MB, which is 90.86% smaller than MobilenetV3_large, resulting in a 30% reduction in training time. Additionally, Table 3 highlights Stairnet's clear efficiency advantage over models like VGG_bn and GoogLeNet.

In addition, precision and recalls for crack types are calculated and summarized using the test sets as shown in Table 4. Compared to the general CNN, Stairnet has higher accuracy and recalls for most crack types, for example, 0.90 and 0.94 for mesh crack and 0.70 and 0.88 for VGG16_bn.

The precision is the proportion of all positive samples that are judged to be true, the higher the precision, the lower the probability of network false positives. Precision is calculated as follows:

$$Precision = \frac{TP}{TP + FP} .$$

Recall, true positive (TP) rate, is the proportion of all positive samples predicted true to all actual positive samples. The higher the recall, the lower the probability of network false negative. Recall is calculated as follows:

$$Recall = \frac{TP}{TP + FN} .$$

Specificity, true negative (TN) rate, is the proportion of all negative samples predicted true to all actual negative samples, which is calculated as follows:

$$Specificity = \frac{TN}{TN + FP} ,$$

where TP, TN, false positive (FP), and false negative (FN) are shown in Table 5, the second letter includes P (Positive) and N (Negative) to indicate the predicted case, and the first letter includes T (True) and F (False) to measure the actual case. The explanation is as follows:

TP: The network judges that the sample is positive, and the judgment is true (in fact, the sample is positive).

TN: The network judges that the sample is negative, and the judgment is true (in fact, the sample is negative).

FP: The network judges that the sample is positive, and the judgment is false (in fact, the sample is negative).

FN: The network judges that the sample is negative, and the judgment is false (in fact, the sample is positive).

In conclusion, the Stairnet model proposed in this embodiment exhibits superior classification accuracy for concrete cracks compared to other comparative CNN models, all while maintaining a significantly smaller size.

TABLE 3
Accuracy, loss, model size, and training
time of Stairnet and other CNNs

| | Accuracy | | | | Model | Training |
|---|---|---|---|---|---|---|
| | Train | Val | Loss | | size | time |
| CNN | (%) | (%) | Train | Val | (MB) | (s) |
| Stair net | 82.2 | 95.9 | 0.52 | 0.15 | 1.48 | 1015.82 |
| Alexnet | 80 | 93.7 | 0.63 | 0.25 | 55.6 | 1526.51 |
| VGG16_bn | 76.9 | 86.4 | 0.75 | 0.61 | 527 | 14534.98 |
| Googlenet | 81.3 | 93 | 0.95 | 0.27 | 39.4 | 1689.68 |
| Resnet34 | 80.9 | 89.2 | 0.61 | 0.32 | 81.3 | 4521.46 |
| Mobilenetv3_large | 83.2 | 95.8 | 0.52 | 0.16 | 16.2 | 1458.53 |

TABLE 4
Precision and recall of Stairnet and other CNNs

| Stair net | Precision | Recall | VGG16_bn | Precision | Recall |
|---|---|---|---|---|---|
| Background | 1 | 1 | Background | 1 | 0.25 |
| Hole | 0.95 | 0.88 | Hole | 0.39 | 0.91 |
| IrregularCrack | 0.95 | 0.59 | IrregularCrack | 0.91 | 0.38 |
| MeshCrack | 0.90 | 0.94 | MeshCrack | 0.70 | 0.88 |
| ObliqueCrack | 0.81 | 1 | ObliqueCrack | 0.76 | 0.87 |
| TransverseCrack | 0.84 | 0.97 | TransverseCrack | 0.89 | 0.83 |
| VerticalCrack | 0.90 | 0.92 | VerticalCrack | 0.85 | 0.56 |
| Mobilenetv3_large | Pre | Rec | googleNet | Pre | Rec |
| Background | 1 | 1 | Background | 1 | 0.92 |
| Hole | 0.95 | 0.9 | Hole | 0.42 | 0.82 |
| IrregularCrack | 0.91 | 0.65 | IrregularCrack | 0.89 | 0.49 |
| MeshCrack | 0.91 | 0.92 | MeshCrack | 0.91 | 0.88 |
| ObliqueCrack | 0.82 | 0.98 | ObliqueCrack | 0.72 | 0.87 |
| TransverseCrack | 0.88 | 0.97 | TransverseCrack | 0.82 | 0.60 |
| VerticalCrack | 0.88 | 0.92 | VerticalCrack | 0.87 | 0.58 |
| resNet34 | Pre | Rec | AlexNet | Pre | Rec |
| Background | 0.99 | 1 | Background | 1 | 0.95 |
| Hole | 0.92 | 0.81 | Hole | 0.72 | 0.78 |
| IrregularCrack | 0.96 | 0.43 | IrregularCrack | 0.88 | 0.46 |
| MeshCrack | 0.88 | 0.92 | MeshCrack | 0.80 | 0.95 |
| ObliqueCrack | 0.74 | 0.98 | ObliqueCrack | 0.77 | 0.99 |
| TransverseCrack | 0.78 | 0.97 | TransverseCrack | 0.87 | 0.89 |
| VerticalCrack | 0.87 | 0.90 | VerticalCrack | 0.85 | 0.84 |

TABLE 5
Meaning of TP, TN, FP, and FN

Predicted results

| | Positive | Negative |
|---|---|---|
| Evaluation indicators | samples | samples |

| | | | |
|---|---|---|---|
| Actual situations | Positive samples | TP | FN |
| | Negative samples | FP | TN |

The above is only an embodiment of the present disclosure and is not intended to limit the present disclosure. Any modifications, equivalent substitutions, and the like made within the spirit and principles of the present disclosure shall be included in the scope of protection of the present disclosure.

What is claimed is:

1. A three-stage modularized CNN for rapidly classifying concrete cracks in images, comprising the following steps:
a concrete crack dataset is built for training the CNN;
the structure of the three-stage modularized CNN, which could be called Stairnet, consists of an input layer, blocks of stair1 in early layers, a convolutional block attention module (CBAM), blocks of stair2 in mid-layers, another CBAM, blocks of stair3 in late layers, and a fully connected layer;
the shallow layers of the model can be referred to as stair1 and are constructed using inverted residual blocks that exclusively consist of convolutions (Convs);
the mid-layers of the model can be referred to as stair2 and there are more layers in stair2, compared with stair1 and 3; the structural blocks in stair2 have two variations;
when the stride is set to 1, the stair2 structure involves performing a split operation on the input channel; one part of the channel passes through an inverted residual structure that includes a depthwise separable convolution (DConvs), while the other part does not undergo any operation; a shuffle operation is performed on the two channels that are concatenated;
when the stride is set to 2, the stair2 structure involves copying the input channel; one part of the channel is reduced in dimension through an inverted residual structure with a depthwise separable convolution, another part is reduced in dimension through the depthwise separable convolution, and the third part is reduced in dimension through maximum pooling; a shuffle operation is performed on the three channels that are reduced in dimension after performing a concatenate operation;
the deep layer of the model can be referred to as stair3, including inverted residual structures containing depthwise separable convolutions and efficient channel attention (ECA) modules.

2. The three-stage modularized CNN for rapidly classifying concrete cracks in images according to claim 1, wherein an expansion factor of the stair1 is 1 or not.

3. The three-stage modularized CNN for rapidly classifying concrete cracks in images according to claim 1, wherein the input layer comprises a convolution layer, a batch normalization (BN) layer, and an activation function (AF) layer.

4. The three-stage modularized CNN for rapidly classifying concrete cracks in images according to claim 3, wherein normalization processing of the BN layer is shown in the following formulas:
wherein xᵢ is a feature map before inputting to the BN layer, yᵢ is a feature map after outputting from the BN layer, m is the number of feature maps input to the layer in the current training batch, and y and B are variables that vary with network gradient renewal.

5. The three-stage modularized CNN for rapidly classifying concrete cracks in images according to claim 3, wherein the AF layer performs non-linear processing via data of an ReLU6:
$$f ( {x}_{i} ) = min ( max ( {x}_{i} , 0 ) , 6 ) ,$$
wherein xᵢ is a feature map before inputting the ReLU6, and f(xᵢ) is a feature map after outputting the ReLU6.

6. The three-stage modularized CNN for rapidly classifying concrete cracks in images according to claim 3, wherein the AF layer performs non-linear processing via data of a Hardswish:
wherein x is a feature map before inputting the Hardswish, and f(x) is a feature map after outputting the Hardswish.

7. The three-stage modularized CNN for rapidly classifying concrete cracks in images according to claim 1, wherein the ECA attention mechanism performs cross-channel interaction on data to obtain an enhanced concrete crack feature extraction map;
$${E}_{s} ( F ) = σ ( {f}^{k * k} [ AvgPool ( F ) ] ) ,$$
wherein |t|_{odd} represents the nearest odd t; C represents the number of channels inputting data into the ECA attention mechanism, and γ and b are two hyper-parameters; γ is set to 2 and b is set to 1; Eₛ(F) is the ECA attention mechanism, σ is a sigmoid operation, f*^{*k} [·] represents performing a k*k convolution operation, F is the input feature map, and AvgPool( ) is the average pooling operation.

8. The three-stage modularized CNN for rapidly classifying concrete cracks in images according to claim 1, wherein in the CBAM attention mechanism, the average pooling and maximum pooling are used to aggregate spatial information of the feature map, compress spatial dimensions of the input feature map, and sum and merge element by element to generate a channel attention map:
$${M}_{c} ( F ) = σ ( MLP ( AvgPool ( F ) ) + MLP ( Max Pool ( F ) ) ) ,$$
wherein Me represents the channel attention, and MLP( ) is composed of fully connected layer 1+ReLU6 activation function (AF)+fully connected layer 2; σ is the sigmoid operation, F is the input feature map, AvgPool( ) is the average pooling, MaxPool( ) is the maximum pooling, Mₛ represents the spatial attention mechanism, σ is the sigmoid operation; and
the average pooling and the maximum pooling methods are used to compress the input feature map in a spatial attention module, to obtain a feature extraction map containing more crack information:
$${M}_{s} ( F ) = σ ( {f}^{7 * 7} [ AvgPool ( F ) , Max Pool ( F ) ] ) ,$$
wherein Mₛ represents the spatial attention mechanism, σ is the sigmoid operation, f^{7*7} [·] represents performing a 7*7 convolution operation, F is the input feature map, AvgPool( ) is the average pooling, and MaxPool( ) is the maximum pooling.

9. The three-stage modularized CNN for rapidly classifying concrete cracks in images according to claim 3, further comprising:
using a dropout layer in each layer to avoid network over-fitting;
wherein the Bernoulli(p) function is used to generate a probability vector, to enable a neuron to stop working with the probability p, and y⁽¹⁾ is an output feature map of the previous layer, and is a feature map output after passing through the dropout layer.

10. The three-stage modularized CNN for rapidly classifying concrete cracks in images according to claim 1, further comprising:
optimizing network internal parameters using the following Adam algorithm:
$$f ( θ ) = Loss ( {y}_{o , c} , {p}_{o , c} )$$
$${m}_{t} = {β}_{1} \cdot {m}_{t - 1} + ( 1 - {β}_{1} ) \cdot {g}_{t}$$
wherein Loss(y_{o. c}, p_{o. c}) is a loss function between a predicted value and a true value of the network; θ is a parameter to be updated in the model; gₜ is a gradient obtained by deriving θ from the loss function f(θ); β₁ is a first moment attenuation coefficient; β₂ is a second moment attenuation coefficient; mₜ is an expectation of the gradient gₜ; vₜ is an expectation of is an offset correction of mₜ; is an offset correction of vₜ; θₜ₋₁ is a parameter before the network update; θₜ is a parameter after the network update; and α is a learning rate.
